(19) United States
(12) Patent Application Publication
(10) Pub. No.: US 2019/0253558 A1
(43) Pub. Date: Aug. 15, 2019

(54) SYSTEM AND METHOD TO AUTOMATICALLY MONITOR SERVICE LEVEL AGREEMENT COMPLIANCE IN CALL CENTERS

(71) Applicants: Risto Haukioja, Palo Alto, CA (US); Chandra Jonelagadda, Princeton Junction, NJ (US); Bipul Kumar, Hyderabad (IN); Biswajit Dev Sarma, Gauhati (IN)

(72) Inventors: Risto Haukioja, Palo Alto, CA (US); Chandra Jonelagadda, Princeton Junction, NJ (US); Bipul Kumar, Hyderabad (IN); Biswajit Dev Sarma, Gauhati (IN)

(21) Appl. No.: 15/894,939

(22) Filed: Feb. 13, 2018

(51) Int. Cl. H04M 3/51; G10L 15/06; G10L 15/22; G10L 25/63

(52) U.S. Cl. CPC H04M 3/5175; G10L 15/063; H04M 2203/401; G10L 25/63; G10L 15/22

(57) ABSTRACT

A system and method for comprehensive automated call center customer/agent interaction monitoring and service level agreement (SLA) compliance. The system reduces a massive volume of call center activity into readable data points and SLA metrics for measuring agent and overall call center performance levels. The system allows for the scaling up of the SLA compliance process, which is currently done manually by quality assurance personnel for a limited sample set. With the system, customer calls are computationally sampled for speaker diarization and voice isolation, speech emotion recognition, unique salient feature extraction, reference pattern template matching, and automatic speech recognition. The system is adaptively programmable for recognizing and predicting SLA metrics such as: customer satisfaction, issue resolution, appropriate agent greeting and identification, customer understanding, acknowledgment, abandonment, sales attempts, and customer retention, etc. Rating scores are assigned to SLA metrics by intelligent speech emotion pattern recognition and machine learning algorithm. The system provides for cost-effective SLA metrics and quality assurance at scale, with agent performance statistics, customer satisfaction data, and additional insights, via system generated reports and live activity streams.

### BACKGROUND

Call centers are typically set up to field hundreds to thousands of customer calls per day to act as the agent/customer points of contact for dealing with a wide variety of context specific issues ranging from accessing information and customer accounts, logging complaints, booking reservations, signing up new accounts, providing technical support, gathering survey data. In some cases, the agents would also be required to play a more active role such as helping with customer retention, or closing sales of products or services, etc. The quality of service provided by the call center is important to not only the customer's satisfaction and loyalty, but also to the entity that has contracted with the call center for service. It is typical for many businesses or other entities to outsource call center resources in order to reduce cost and to leverage firms with specialized skills and experience in customer service. The contracting party will require the call center to follow a service level agreement (SLA) with specific protocol governing the agent/customer interaction. The SLA will specify exactly how the call center is to handle the important responsibility of answering, servicing and managing customer calls.

The SLA describes the service that the call center is to perform for the contracting business, as well as more specific items such as how the call center agent is to identify him or herself, how the agent is to formally greet the customer, what type of services the agent is to render the customer, and typically includes a set of context specific performance metrics to be attained, i.e., the SLA metrics. The SLA metrics may indicate the level of customer satisfaction, overall customer experience, the issue resolution score, length of call, the agent's attempt to negotiate, the customer's level of happiness, the agent/customer engagement level, how the call is trending with respect to quality, etc. Together the SLA contract and the SLA metrics govern the job duties and performance rating of the customer service representative and the call center on behalf of the parent contracting business entity.

Current methods for measuring the quality and assigning a grade or score to the call center agent's performance is for the most part a manual undertaking. Pursuant to the SLA contract, the call center will assign a quality assurance (QA) individual to manually monitor and listen to a small subset of agents and their customer interactions. For example, a call center may provide a single QA specialist per thirty to fifty (30-50) customer service agents. Or alternatively, the SLA may stipulate the manual monitoring by the QA agent of three to five percent (3-5%) of each customer service agent's calls. This is an incomplete, expensive and time consuming process, as it is done by the QA person listening in real-time or to call recordings and then assigning SLA metrics and ratings to the calls. Most calls are not evaluated by the QA process due to time, cost and limited resources. The end result of the QA process is a snapshot of each agent's performance and an incomplete estimation of metrics from the limited subset of manually reviewed calls. With this methodology, the vast majority of calls are not monitored and go completely unreported to the QA personnel. The contracting business is only able to see a tiny fraction of SLA metrics from an incomplete picture of the overall call center activity. Moreover, the SLA metrics that are generated by the QA person only measure the professionalism and quality of the agent's performance. The correlation between the agent's performance and the overall business objectives and goals of the business entity which the call center is serving is not explicitly demonstrated. Additionally, the SLA metrics do not address how agents performance in light of customers' mood and temperament.

The range of services that may be provided by a call center, and a team of well-trained customer service agents, is unlimited and broad. The value recognized to the business end-user of call centers is clearly shown in an improved level of customer satisfaction, retention, and goodwill. The business user will therefore realize greater customer happiness by contracting with experienced, cost-effective, and impactful call centers for the delivery of customer relationship management services.

The delivery of services by the call center to the customer or client is typically governed by a service level agreement (SLA) that is negotiated between the contracting business entity and the call center services provider. The sophisticated business end-user will desire to tightly control the protocol for interaction between the call center agent and the customer or client. The SLA will specifically lay out the rules for customer engagement, describe how to respond to customer requests, explain what services to provide the customer, and essentially govern and control the agent/customer interaction experience. The SLA in many respects acts as a playbook for the call center in the performance and fulfillment of the contract with the business end-user entity. It is therefore in the business user's interest to monitor call center activity, require quality assurance, and accumulate meaningful SLA-metrics for assessing customer satisfaction and analyzing the agent's performance of contractual duties.

### SUMMARY

With the presently described system and method, the service level agreement (SLA) monitoring and compliance process would be automated and comprehensively scaled by technology assisted agent/customer call sampling, speech and emotion recognition, salient feature extraction, and adaptive machine learning pattern recognition and reinforcement. The system broadly expands the coverage of the quality assurance (QA) process by applying automated monitoring to larger set of calls, than the previous manual process, and preferably may be used to provide complete coverage and monitoring of all agent/customer calls or interactions. A set of SLA metrics and call resolution ratings and other contextual or application specific data points are generated by the system to provide individual agent and overall call center performance levels.

Each call is recorded or monitored and sampled live in real-time by the system. Ideally, the calls would be recorded on multiple tracks/channels, wherein each track/channel contains the voice of just one person. In case the recording or the audio system is unable to provide this separation in a natural manner, the described system would apply Speaker Diarisation, a technique that distinguishes between different speakers, to isolate the voices of the various agents, the customer, and other people on the line. In either case, naturally separated or diarised, all subsequent processing of the voices is identical. The following methods are applied to the voice information: 1) Automatic speech recognition (ASR) is used to output a searchable text transcript of the call; 2) Speech emotion recognition (SER) is performed to compute the emotion spectrum of the voices, i.e., happy, sad, angry, neutral, etc.; and 3) The system is also trained to extract and recognize contextually salient features from the audio sample and ASR/SER data, such as: a) Whether the agent allowed the customer to finish before responding; b) Whether the agent maintained an even emotional keel (If the agent's emotions are maintained when interacting with an irate or angry customer, this additional fact is also noted); c) Whether the agent acknowledged the problems of the caller; d) Whether the agent displayed accurate knowledge of product offerings; e) Whether the appropriate greeting was used; f) Contextual information about the manner in which the call terminated; g) Whether or not the the customer's concerns were resolved; and h) Non-verbal cues, etc.and other classification patterns or features.

The system will produce and generate matching SLA metrics and scoring data to the manual QA process, but will additionally go beyond by comprehensively providing coverage to potentially all agent/customer interactions that pass through the call center system network. Calls will preferably be monitored and sampled in real time, or from recordings, and the system will generated reports in batch or alternatively show live streaming SLA metrics and performance indicators to the customer service agents, QA personnel, or supervising staff.

The system will properly allow the determination of value of each individual agent and call center to the contracting business or end-customer. The Call Center operators may use the SLA metrics generated by the system to identify low performing agents and assign them for retraining, while higher performing agents may be assigned QA roles, or be given training duties. The system's detailed report would include specific aspects of the interactions for improvement, such as identifying interruptions, being unable to maintain an even temperament when dealing with irate customers, etc., for all the analyzed calls. Metrics such as these would have required manual assessment and annotations of the calls, which would actually be cost-prohibitive for all but a small proportion of the calls.

High level data-driven insights into the agent/customer interaction will be possible given the large scale automated sampling of call center data resulting in a more effective delivery of value to the SLA contracting entity. With reinforcement adaptive machine learning, pattern recognition, and artificial intelligence, the system will be trained to provide context specific assessment metrics given the specialized nature of the call center use-case scenario.

The system may be embodied in a tangible computer readable medium comprising processor-executable code. In an embodiment, when executed by a processor, the processor-executable code may cause the processor to perform certain operations. In an embodiment, the operations may include passively monitoring the call center's communications system that is related to handling calls with customers, automatically processing the calls for quality metrics, generating a record to save the information about quality metrics in a data storage device. In another embodiment, the processor-executable code may operate on recorded conversations, processing the calls for quality metrics, and generate records to save the information about quality metrics in a data storage device.

The system may be embodied in a client device with network connectivity to a remotely or cloud-hosted software platform running on a server computer. The client device may comprise a computer with tangible computer readable medium comprising processor-executable code. The server computer may comprise server grade computer hardware with tangible computer readable medium comprising processor-executable code. In an embodiment, when executed by a processor, the processor-executable code may cause the processor to perform certain operations. In an embodiment, the operations may include passively monitoring the call center's communications system that is related to handling calls with customers, automatically processing the calls for quality metrics, generating a record to save the information about quality metrics in a data storage device. In another embodiment, the processor-executable code may operate on recorded conversations, processing the calls for quality metrics, and generate records to save the information about quality metrics in a data storage device.

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

### DESCRIPTION OF THE DRAWINGS

FIG. 1 is a view of the system to automatically monitor SLA compliance in call centers.

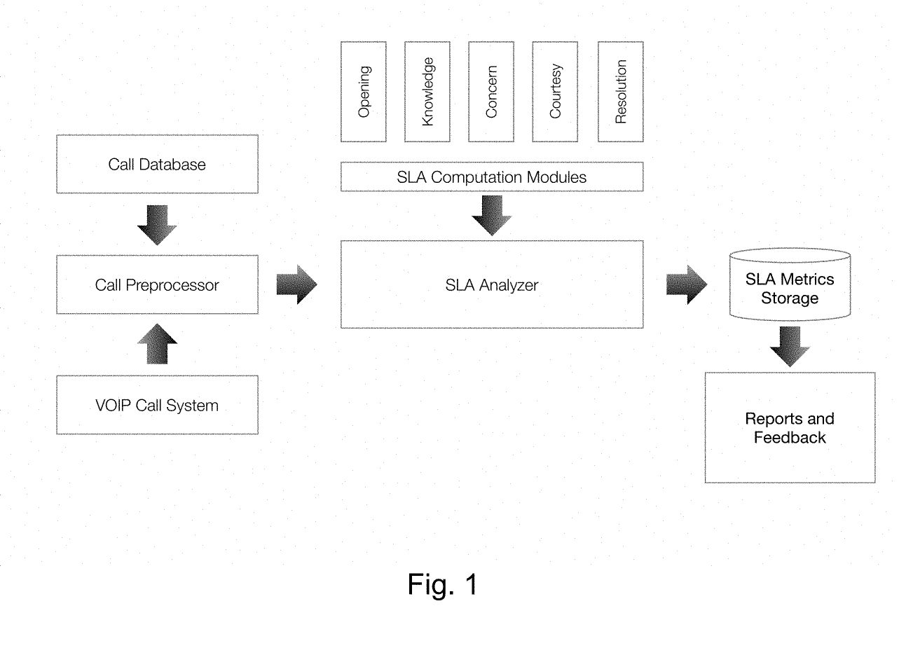

FIG. 2 is a view of the salient feature extraction and pattern recognition process.

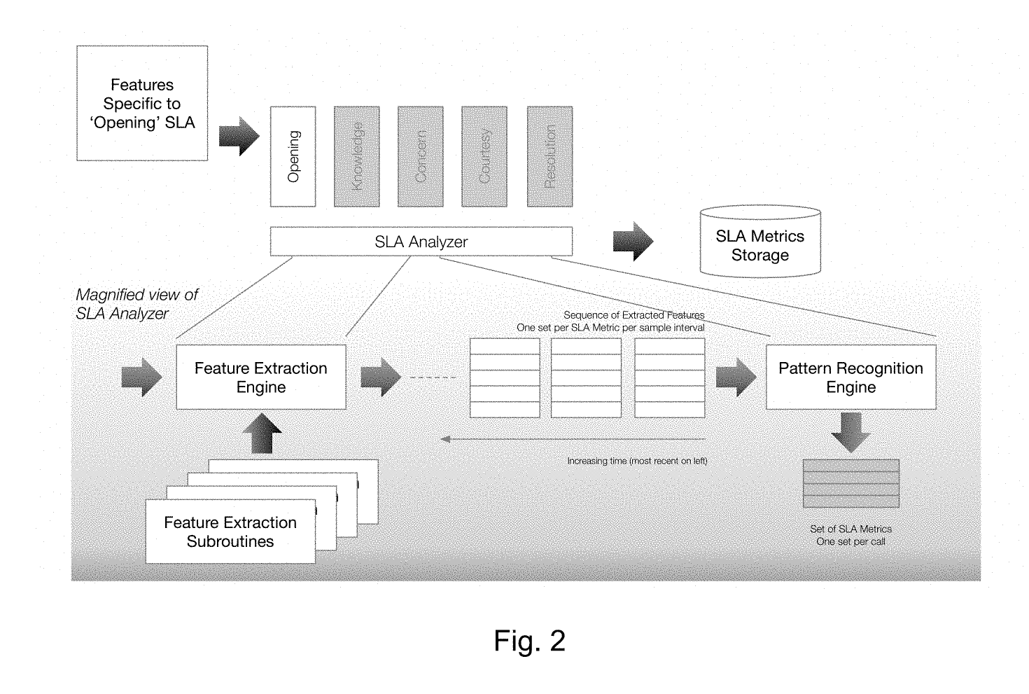

FIG. 3 is a view of the call center agent or operator customer interaction phone call audio signal speech and voice data with speech emotion recognition (SER) data.

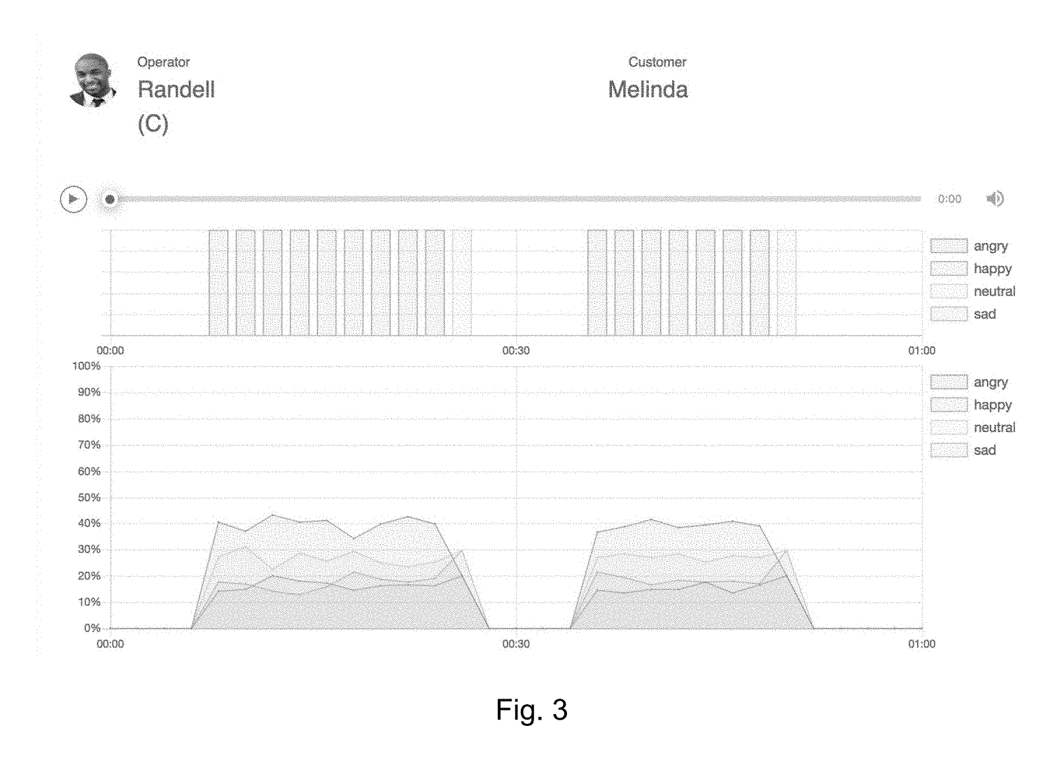

FIG. 4 is a view of the call center agent or operator profile data, performance metrics, SLA score, customer happiness, and operator sentiment data metrics.

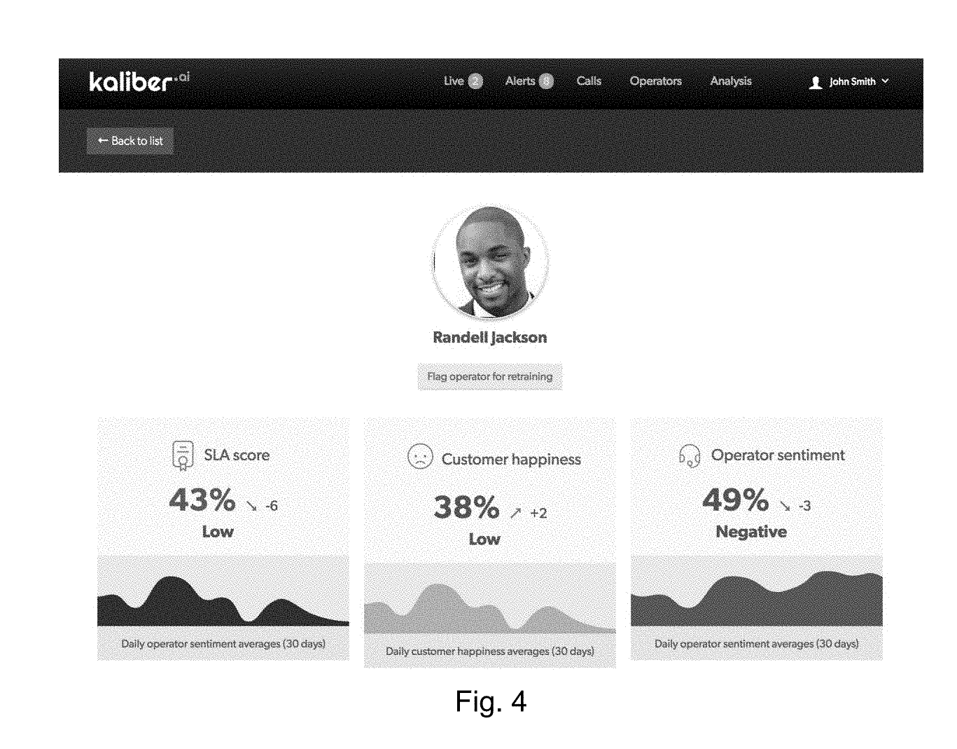

FIG. 5 is a view of the call center customer sentiment and SLA metric data as well as call center agent or operator SLA metric performance data, top performers, lowest performers, number of phone calls per agent, and average SLA metric data.

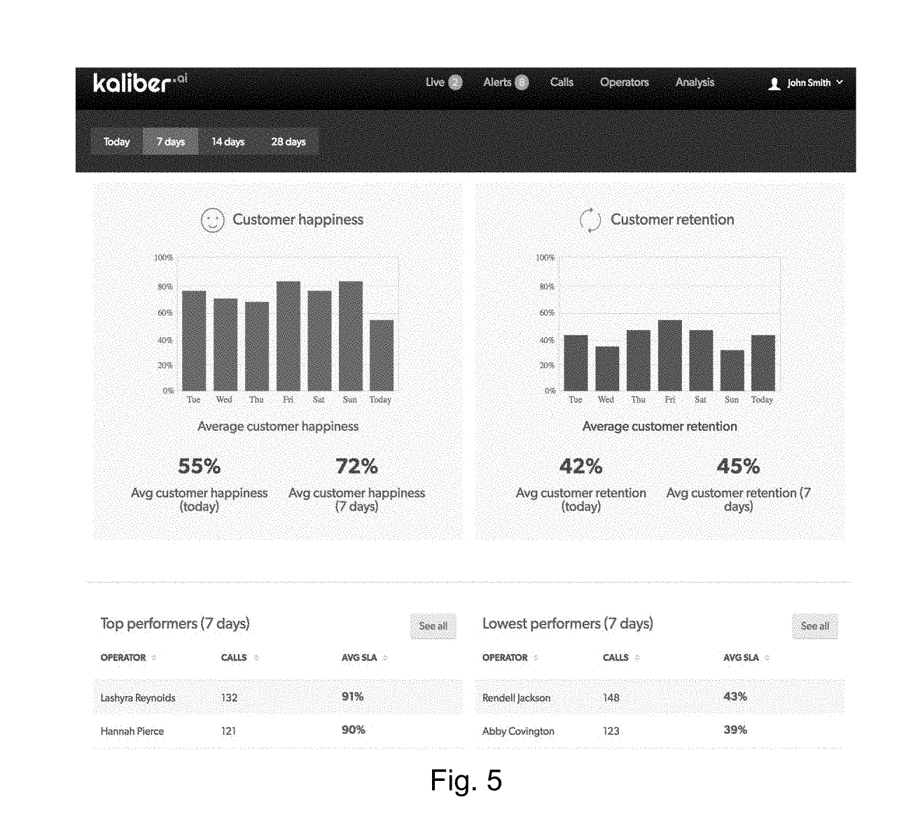

FIG. 6 is a view of the call center SLA metric performance data, number of calls per day, average number of calls per day, average SLA score, average SLA score per day.

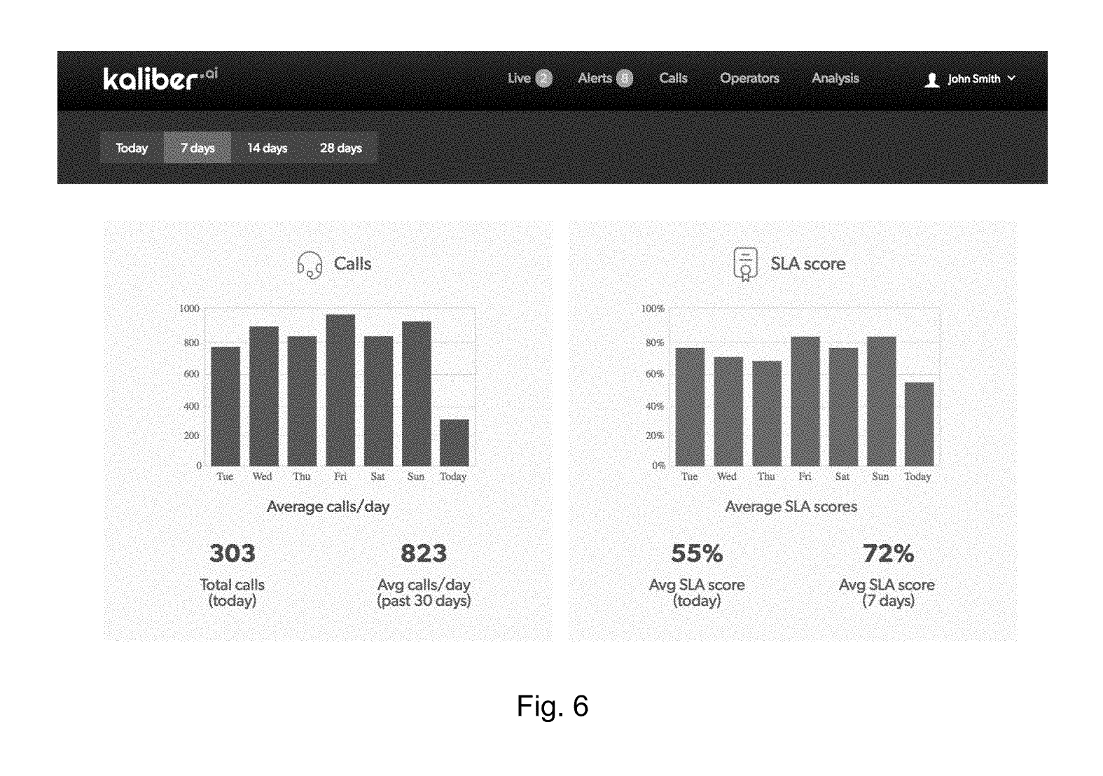

### DETAILED DESCRIPTION

The presently described system and method provides the ability for call centers to comprehensively monitor and analyze agent/customer interactions, provide automated quality assurance (QA), and predict service level agreement (SLA) metrics. The system computationally processes the audio feed from customer calls and applies novel, salient feature recognition and extraction methods in order to infer and generate pertinent information and metrics. In contrast to contemporary methods, the system goes beyond merely converting verbal speech to text and searching or matching keywords and spoken words. The present system finds, samples, and models hundreds of unique salient features by using an artificial intelligence, machine learning and pattern recognition and classification approach. The system is furthermore adaptively trained through reinforcement learning, template feature matching, tuning and adjustment for improved accuracy in predicting SLA performance statistics, metrics, and other context specific performance indicators.

In a preferred use case, the call center that utilizes the present system may have specific goals and performance metrics as defined in the SLA, and contracted with the business user end-customer. For example, the call center may be specifically tasked with the objective of customer retention and preventing loss of accounts. Alternatively, the call center may specialize in providing technical support, securing reservations, developing business, signing up new accounts, gathering survey or questionnaire data, providing help line information, giving access to customer account data, selling products and services, or facilitating emergency and government services, etc.

### DESCRIPTION OF STATE OF THE ART

Contemporary methods for quality assurance (QA) of the agent/customer interaction is typically done by a manual sampling of customer calls by a QA agent who listens to, scores, and provides descriptive information on a small subset of calls (i.e., three-five [3-5] calls per week, per agent; three-five percent, [3-5%], of all call center/agent calls; or other sampling rates) for customer experience, issue resolution, appropriate greeting, agent identification, etc. However, this approach is limited, does not provide complete coverage of all agent/customer interactions, is time consuming, expensive, and resource intensive. The technology assisted approach in the presently described system aims to provide cost effective, broad and complete coverage, and monitoring of all agent/customer interactions and the generation of insightful SLA metrics.

The system preferably functions by the automated sampling of the audio signal from the customer service call between the agent and the customer or client. The sampling may be done in real time, over the call center VoIP telephone network, performed on a recording of the call, or electronically stored file. The system may preferably utilize a software application for sampling the agent/customer phone call audio signal data and performing preprocessing, filtering, noise reduction, and speaker diarization.

### General Description of Techniques to Measure SLA

While the system is capable of measuring a variety of SLA measures, the system utilizes common procedures with the primary goal of being able to mimic the function of a human performing the quality assessment task. The general outline of the procedure consists of: 1) Obtaining results of manual quality control assessments; 2) Determining factors that lead a human assessor to assign a given rating; 3) Developing algorithms to discern/extract information used by the human assessors; 4) Training a Machine Learning System with the mechanically extracted features and human assigned scores, this would result in the adjustment of the internal parameters of the system to match the human performance; and 5) Testing the system with data not seen during the training and documenting the benchmarks such as, accuracy of classification, average errors, and known limitations.

### Step 1: Preprocessing—Speaker Diarization

With the presently described system, speaker diarization is initially performed on the call audio signal in order to separate out the multiple voices or speakers that may be heard on a single customer call. In many instances, a customer call is forwarded and passed along to more than one agent in a call center depending on the situation. The different voices may preferably be isolated by slicing the audio signal file into multiple pieces and then grouping the slices into similar units, then counting the units, and therefore determining the number of distinct speakers or voices on the call. Additionally, the distinct speaker identities are separated in order to perform the system processing for unique salient feature extraction on each voice separately and correlating the results with the correct speaker.

### Step 2: SLA-Specific Salient Feature Extraction

Salient feature extraction is preferably performed by unique algorithm for each feature as specified in the SLA contract or for the particular call center use-case scenario. The system can then properly assign SLA metrics to the call center agents and determine the customer's satisfaction or level of happiness, by isolating the unique voices on the call. The system will additionally perform digital signal processing techniques such as noise reduction, pre-processing, and filtering in order to provide an audio sample with appropriate sample rate, sound quality and resolution for the system's next level processing stages.

Since speaker diarization is the first step in the processing, the system thereafter operates on the audio signal in order to perform unique salient feature extraction and pattern recognition. The time varying audio signal sample may be divided into a series of frames by a feature extraction engine for feature extraction and processing.

### Step 2.1: Measuring Courtesy

An important salient feature of the agent/customer call is a measure of the measuring the level of courtesy afforded to the customer or client by the agent. The system preferably measures the courtesy level by direct and indirect means. The emotional responses of the call and the agent may be overlaid onto the audio signal for correlating patterns in the sample. For example, the system may sample the audio signal, isolate the customer's voice, and then overlay the description of the emotional state of the customer for each time slice of the audio sample. The customer's audio sample will preferably by given emotional labels describing the state of mind of the customer throughout the entire call.

The direction of customer satisfaction trending during the call, whether upwards, downwards, or evenly, may be displayed by the system. Emotional pattern recognition may be performed by grouping the sampled audio frames according to feature extraction and system model classification. The call may start of with the customer in an unhappy emotional state, but end with a satisfied state of mind. The system provides a truer snapshot of the agent/customer interaction and overall customer satisfaction by automatically generating emotional tags and labels throughout the customer call. In a preferred embodiment, the system generates a live customer satisfaction level during the call, indicating trending towards dis-satisfaction, concern acknowledgment, resolution, exceeding expectations, or happiness, etc.

The system may comprise the following features: 1) Caller's Speech Emotion Readings measured over the duration of the call. The emotion readings, also known as SER (abbreviation for Speech Emotion Recognition) labels, also contain temporal information; 2) Agent's SER labels measured over the duration of the call; 3) Number of interruptions, as indicated by the amount of overlap between caller's voice and the agent's voice, see details below; 4) Emotional disparity during the interruption, in case the agent has to gently interrupt the caller to bring the conversation back into focus; 5) Words or phrases that could indicate the customer complaining about being able to finish their statement; 6) Emotional readings at the start and the end of the call of both the agent and the caller; 7) The direction of customer satisfaction trending during the call, whether upwards, downwards, or evenly, computed from the SER label time-series information. The system may use the Support Vector Machine Classifier (SVM) algorithm.

### Feature Extraction Details

In a preferred embodiment, the system preferably utilizes a feature extraction engine with pattern recognition and classification techniques to extract and recognize salient features in the the audio signal data. The sampled audio signal frames may be grouped and clustered according to SLA metric defined classification, pattern recognition, speech emotion recognition, or system provided reference template patterns. An important salient feature is whether the customer service agent allows the customer or client to finish speaking before responding. The system will determine the feature of whether the agent interrupts the customer by initially performing speaker diarization and isolation. Thereafter, individual voices will be assigned a waveform pattern or shape representing each voice in isolation, for example, a certain waveform will correspond to customer's voice and a different waveform will describe the agent's voice. For instances of the call audio data that pattern match the combination of the agent and the customer's voice, the system will recognize these situations as occurrences of speaker interruption, or when both the agent and the customer are speaking at the same time. An interruption on behalf of the agent will be counted as occurring when the agent/customer waveform combination is encountered by a preceding instance of the customer's voice. Alternatively, an interruption of the agent will be recognized as occurring when the agent's waveform precedes the agent/customer combination waveform. With this approach, the system is able to assign labels for the negative impactful instances of agent interruption and provide useful SLA reporting metrics of call center agent performance.

Another important salient feature for recognition is whether the agent maintains an even emotional keel, calmness or level of professionalism during the customer interaction. This is an example of a positive impactful call center agent performance metric. In a preferred embodiment of this feature recognition, the agent's voice will initially be isolated from the call audio signal and sampled for emotional feature data. The agent's audio signal will be sampled, pre-processed and undergo frame division splicing. The sample frames will be analyzed for features, then grouped and clustered according to pattern templates and speech emotion recognition.

The appearance of a neutral, engaged, professional tone will be measured from the agent's audio waveform and sample frames data. The system preferably uses pattern matching, grouping, clustering, and classification to identify and label the time sliced samples of the agent's voice. Each sample slice is analyzed by the system to determine the agent's precise state of mind and emotional level. The summation of the emotional labels, and sample frame grouping distribution, should produce a average emotional reading of even, calm, and professional as required by the SLA metrics for the specific call center use case. For example, the agent's voice audio signal data may in aggregate show a certain averaged excitation level throughout the call. Depending on the specific call center customer service application, the excitation pattern may or may not comply with the SLA requirements. In the application of an emergency services call center, the agent's maintenance of an even, calm emotional keel is paramount for the effective communication with the caller during the emergency. In this application, the system will sample the agent's voice and flag for review any instances of non-calm, excitation, or abnormal speech or vocal qualities on the part of the call center agent. Alternatively, in a call center application use case for customer account dispute resolution, the SLA may require the agent to address the customer with an certain level of calmness, and even emotional keel, whereas the customer may be speaking with an upset and dissatisfied emotional tone. The system will be able to isolate the customer's voice from the agent's with diarization methods and accurately assign performance metrics to the agent without interference from the customer's voice sample data.

### Step 2.2 Acknowledging the Caller's Problems/Issues

In a preferred embodiment, the system provides insight into whether the call center agent acknowledges the problem or issues of the caller. Customer acknowledgment is an important and beneficial metric to the overall customer satisfaction level as a person that perceives being understood by the call center agent will tend to view the interaction with the call center as a productive and effective experience. The customer that perceives the agent as accepting the truth of the customer's concern, appreciating the existence of the customer's problem, or confirming the customer's circumstances, is likely to have a higher customer satisfaction level. Therefore, the system will preferably extract and recognize the feature of acknowledgment through pattern matching and salient feature extraction. For example, the system may implement this functionality in the use-case of a technical support call center. A caller will access the system by dialing in and speaking with the customer service agent. Upon asking the caller to state their concern, the customer's audio sample will include a description of the problem. The system will preferably utilize an automatic speech recognition (ASR) module to generate speech to text translation of the customer's concern. In response, preferably the call center agent will reply with verbal phrases such as “I understand”, or other acknowledgment confirming the customer issue. The system will positively adjust the customer satisfaction metric accordingly with a measured acknowledgment pattern. An instance of not understanding the customer's issue may be interpreted by the system recognizing the customer or client repeating the issue, i.e., by noticing instances of multiple repetition of problem-descriptive words or phrases in the customer ASR data.

The system may preferably comprise the following features: 1) Words or phrases that could indicate the agent is acknowledging the customer's problem/issue; 1)(a) This feature does not rely on just matching keywords but also on understanding equivalent words and phrases that could imply the same sentiment; 2) Emotional readings at the start and the end of the call of both the agent and the caller; and 3) The direction of customer satisfaction trending during the call, whether upwards, downwards, or evenly, computed from the SER label time-series information. The system may preferably use the Support Vector Machine Classifier (SVM) algorithm.

### Step 2.3: Measuring the Agent's Knowledge of the Products

In a preferred embodiment, the system provides insight into whether the customer service agent is displaying knowledge of the product offerings, preferably as a site-specific implementation, and as described by the product technical literature, product manuals, or product technical support website data. The system will be programmed to have a working knowledge or body of language corresponding to the technical terms, phrases, and descriptions of the specific product. During the agent/customer interaction, the system will utilize ASR speech to text data of the agent's conversation during the call. The ASR text will be compared and correlated with the body of language referencing the product offerings.

The system will assign a scoring method to indicate instances of the agent properly and accurately demonstrating knowledge of the specific product offering. For example, if the customer is calling a technical support line for information regarding the operation of video editing software, and the agent relays accurate sequential editing steps and work-flow descriptions that directly correlate with with video editing software manual, technical literature and product release notes, the salient feature of displaying knowledge of the product offering will be scored highly. The recognition of the feature of demonstration of product knowledge is end-customer specific and will necessitate that the system is directed to, supplied with, or uploaded relevant product literature information for comparison with the phone call ASR speech to text data.

An additional layer of product knowledge salient feature extraction is possible with speech emotion recognition (SER) data overlaid with the previously described ASR speech to text product offering description correlation. In a preferred embodiment of SER augmented product knowledge demonstration, the agent's voice is sampled and processed for emotional state during the product offering sections of the call. For example, the business end-customer may require in the SLA contract that the call center agent display knowledge of the product or service with an excited and confident tone of voice. The call center may service a financial services firm and provide support for the sales and trading of financial instruments and securities. The agent's performance during a sales call with a customer will preferably be sampled for accurate assessment of the agent's ASR speech to text data and correlation of the agent's description with, for example, a certain cryptocurrency's current pricing, 30/60-Day volatility index, and price to sales ratio, etc. Additionally, the agent's voice audio data will be sampled for emotion or state of mind pattern recognition for the required level of excitation and confidence, and therefore provide an accurate performance metric for the financial service firm end-customer. A simple reading of the text of the conversation would not provide an accurate picture of the caller's satisfaction with the agent's performance. As is well known, identical words could be uttered with different emotions.

The system may preferably comprise the following features: 1) Words or phrases that could indicate the agent is acknowledging the customer's problem/issue, this feature does not rely on just matching keywords but also on understanding equivalent words and phrases that could imply the same sentiment; 2) Emotional readings at the start and the end of the call of both the agent and the caller; and 3) The direction of customer satisfaction trending during the call, whether upwards, downwards, or evenly, computed from the SER label time-series information. The system may preferably use the Support Vector Machine Classifier (SVM) algorithm.

### Step 2.4: Measuring the Agent's Opening Greeting and Introduction

In another preferred embodiment, the system will perform analysis on whether the agent provides the appropriate greeting to the customer. The specific greeting is business end-customer specific and depends on the type of call center application. For example, a call center application for a wireless mobile service may preferably require the agent to formally identify themselves as a representative of the wireless company, provide their name, and start the conversation off with a friendly greeting, ask for account identifying information, security question procedure, etc. In another preferred embodiment, a call center for a government services helpline may require the agent to greet the customer with a friendly and polite agency identification and thereafter gather important caller identification information before proceeding. For example, the government call center might field calls for parking control issues, the agent will begin the call by identifying the municipal office, the agent's name, and gather caller information such as, name, neighborhood, address, and type of problem, before discussing the caller's complaint in detail. In most applications, the greeting protocol will be call center use-case scenario specific and will be described in the SLA contract.

In a preferred embodiment of the system, the call audio signal is initially sampled and speaker diarization is performed to separate out the agent's voice from the customer's. The agent's audio sample will be analyzed by the system ASR speech to text for detection of the appropriate keywords, phrases and adherence to greeting protocol as described in the SLA. The agent's voice will additionally be sampled and analyzed for the assignment of speech emotion recognition (SER) labeling, and salient feature extraction and classification throughout the greeting process. Preferably in most situations, the SLA will specify that the agent greet the customer in a friendly and polite manner and detection of speech waveform patterns that score for friendliness will be used for positively impacting the overall customer satisfaction rating.

In the absence of the emotional labels from the agent's voice, pleasantness and professionalism in the agent introduction cannot be determined accurately. Just the text of the conversation is inadequate; as is well known, identical words could be uttered in different manners to convey different emotions. In the absence of the emotional aspect, SLA scores could not be automatically computed with a high degree of accuracy.

The system may preferably comprise the following features: 1) Words or phrases that could indicate the agent's introduction to the caller, this feature does not rely on just matching keywords but also on understanding equivalent words and phrases that could imply the same sentiment; 2) Emotional readings at the start and the end of the call of both the agent and the caller; and 3) The direction of customer satisfaction trending during the call, whether upwards, downwards, or evenly, computed from the SER label time-series information. The system may preferably use the Support Vector Machine Classifier (SVM) algorithm.

### Step 2.5: Measuring the Agent's Handling of Call Termination

In another preferred embodiment, the system will preferably examine how the agent/customer interaction terminates by performing analysis on the tail end of the phone call. A commonplace example is where the agent asks the customer directly whether their issues or concerns have been addressed or if there is anything else that the agent can help with. The SLA protocol may specify that the agent ask the customer, “Have I been able to address your concerns today?” Ultimately, the examination of the call termination characteristics are performed in order to assess the overall resolution score of the customer concern or issue. The system will perform ASR speech to text analysis on the agent's audio signal data to determine whether the agent has in fact uttered the appropriate closing phrases and keywords. In addition, the system will perform speech emotion recognition (SER) analysis on the agent's voice to provide assessment of the agent's level of professionalism in their tone of voice. Additionally, after the detection of the appearance of the agent's closing remarks, the system may preferably scrutinize the customer's response and provide further customer satisfaction and SLA reporting and compliance data. For example, if the system determines through ASR/SER analysis that the customer has provided a response to the agent's closing remarks indicating that the customer concern has been addressed, if gratitude is detected in the customer's tone of voice, or if ASR data shows the appearance of contextually relevant keywords and phrases, i.e., “Thank you,” then the customer satisfaction and call resolution level will be scored positively. Alternatively, if the system detects a customer response indicating the concern was not addressed and an upset, dissatisfied tone of voice, then the satisfaction and resolution score will be negatively impacted.

In the absence of reading the emotional cues from the caller, the agent's satisfactory resolution of the call could only be inferred by the spoken response of the caller. As is well known, identical words could be uttered in different manners to convey different emotions. In the absence of the emotional aspect, SLA scores could not be automatically computed with a high degree of accuracy. The system may preferably comprise the following features: 1) Words or phrases that could indicate asking agent asking the caller about call resolution, this feature does not rely on just matching keywords but also on understanding equivalent words and phrases that could imply the same sentiment; 2) Emotional readings at the start and the end of the call of both the agent and the caller, unlike in traditional methods, reading the customer's response to the query will indicate the customer's feeling about issue resolution; and 3) The direction of customer satisfaction trending during the call, whether upwards, downwards, or evenly, computed from the SER label time-series information. The system may preferably use the Support Vector Machine Classifier (SVM) algorithm.

### Step 2.6: Extensibility of the System

With adaptive pattern recognition and machine learning, the system is configurable to accommodate a wide range of SLA performance metrics depending on the call center application. The system may be trained to recognize certain patterns indicating the business end-customer's unique requirements, customer interaction procedures, productivity measures, etc. In this approach, the agent/customer calls are compared with an application specific template, reference pattern, or programmable super-set of SLA requirements and metrics. The system administrator will provide the system with a guiding reference pattern, template or framework consisting of problem statements, agent/customer interaction abstractions, heuristic emotional recognition waveforms, and performance rating algorithms.

The system may be provided reference pattern templates for pattern matching and recognition such as text descriptions, written words, spoken voice samples, phrases, or other speech samples. In a preferred embodiment, the system administrator essentially writes a script describing the ideal customer call resolution and satisfaction scenario and inputs this into the system. With artificial intelligence, the system interprets the script to generate a referential model for analyzing customer calls for performance metrics and SLA compliance. The system intelligent agent will preferably generate reference template patterns at the audio sample frames level based on the administrator input heuristics data. The system may be provided with a script describing the preferred greeting, identification information and phrases, a set of required questions to be asked, product or service offering technical literature data, desirable emotional tone overlay, acknowledgment of concern indicia, and ideal resolution scenario, etc. Thereafter, the system artificial intelligence will apply pattern recognition and salient feature extraction to generate a referential model from the input script for scoring SLA compliance and customer satisfaction. The agent/customer interaction will be sampled for patterns matching the informational content and emotional overlay patterns with the referential model and weighted average SLA metrics will be computed for performance, compliance, resolution and satisfaction. For example, the appearance of multiple instances of call center agent description of product or service offerings which match the referential model will return scoring points to preferably trend the performance metric higher. Additionally, the recognition of agent voice audio waveform emotional patterns that match the referential model for even emotional calmness may add points to trend the satisfaction metric higher. The absence of specific required utterances regarding greetings, security questions, upsell attempts, that are otherwise described in the referential model, may trend the performance metric downwards. In effect, the system is provided with input data to appropriately program the recognition of preferred agent/customer interaction behavior and provide reporting metrics with respect to application specific requirements.

### Step 3: Producing Reports and Dashboards

In a preferred embodiment of the SLA metric reporting functionality, the system will provide call center performance metrics on a daily, weekly or monthly basis. Additionally, the system will provide real-time, or live streaming compliance metrics from sampled agent/customer interaction data. SLA metric data may be queried in a system user interface (UI) application based on call center, individual agent, customer, customer group, account status, time period, or other reported metric. Application specific information can be extracted, searched, or queried from the call center activity to show for example, how many customer calls were resolved in a successful manner, for a certain time period. Alternatively the system may report individual agent performance metrics, such as how accurately, or comprehensively, are the agent's describing the product or service offerings. Or furthermore, the system may provide reporting on the level of sales activity attempted with customer contacts by assessing the level of engagement in the agent/customer interaction and the appropriate use of phrases with optimal emotional tone overlay. For example, the system may report that on average each call center agent engaged the customer a certain number of times during the call for sales attempts with an appropriate speech emotion. In another example, the system may provide monthly reporting metrics of successful customer retention numbers by matching agent/customer interactions with customer account data. The customer that calls regarding canceling a service is preferably routed and engaged with a call center agent tasked with saving and retaining the account. Attempts to preserve the customer relationship will be analyzed by the system and added to the system reporting metrics for overall daily, or monthly retention reports. Real-time compliance data is also observable with the system by providing indicators across the call center agent team showing specific activity with respect to SLA metrics. In a preferred embodiment the system can provide live streaming data displaying the agent activity and scoring levels in the areas of greeting, identification, acknowledgment, resolution, engagement, etc. In this manner, the call center performance under the SLA contract can be viewed contemporaneously with live sampling of agent/customer activity data. The system may also provide suggestions, to the call center agent, for improving customer satisfaction based on the sampled agent/customer data. In another preferred embodiment the system may perform data analysis on the agent/customer interaction audio for finding non-verbal patterns or non-lexical cues, such as pauses, hesitation, stuttering, quickness in responding, false starts, restarts, word lengthening, silence, rhythm, call abandonment, hang-ups, etc.

### Ongoing Performance Tuning and Feedback to the System

In order to accurately measure and calibrate the system performance, the system generated customer satisfaction or resolution score will be compared with human generated quality assessment (QA) metrics. With accurate calibration, the quality assurance metrics will preferably match and closely correlate with system generated methods.

From time to time, an agent/customer interaction may be monitored by a human quality assurance agent and assigned scoring for specific SLA metrics. The automated machine generated scoring and reporting will be compared for accurate matching and correlation to the manual QA process. If needed, the system scoring methods and weighted point assignment algorithms may be adjusted to more closely follow the human scored metrics. For example, if the automated system approach is assigning too many points to the agent's discussion of product or service offerings, and this is skewing the customer satisfaction level higher than observed with the manual QA process, the system administrator can adjust or turn down the weight, or assignment of points for this metric. This prevents call center agents from gaming the system. If the manual QA assessment reveals that the customer issues are not being resolved in a timely fashion, the satisfaction scoring should preferably trend downwards and the system referential model will be adjusted to negatively impact customer satisfaction levels for calls matching the profile of the manual QA assessment. The scoring of certain salient features of the call may be automatically varied or weighted differently by the system in order to closely correlate and match the overall assessment provided by the manual QA process. For example, the combination of scoring for greeting, acknowledgment, product/service offering description, resolution, etc., may have different values affecting the overall customer satisfaction level. With input and correlation with a manual QA dataset, the system automated scoring and referential model may be system-adjusted and calibrated to more accurately reflect the actual agent's performance, customer satisfaction, and SLA compliance metrics.

### Description of System to Detect Emotion from Speech

The system may preferably utilize the circumplex model of emotions for performing speech emotion recognition (SER). In this model, human speech and voice data can be modeled as a vector in two dimensions with the voice ranging from low to high pleasantness along one dimension, and low to high arousal in a second dimension. The system task of emotional classification of the human voice from the audio sample is most accurately modeled by extracting and recognizing features with sufficient discriminatory ability to place the speech sample on the circumplex model vector diagram, i.e., by determining the pleasantness and degree of arousal. For example, voices determined to have low pleasantness but having neutral activation would preferably be classified as being sad or upset. The system additionally utilizes digital signal processing (DSP) to extract primary voice features such as pitch, formant frequencies, energy of signal, MFCC (Mel-frequency cepstrum), and loudness, etc. The system speech emotion recognition (SER) reduces the dimension of features by feature reduction techniques and the system ultimately classifies the audio sample. In a preferred embodiment the system performs emotional classification of the sample by labeling with: happy, sad, annoyed, frustrated, angry, formal, casual, enthusiastic, gleeful, afraid, silly, love, aroused, peaceful, embarrassed, pride, apologetic, disapproving, elated, confused, cautious, exhausted, tired, hungry, lost, exasperated, shame, furious, fear, envy, condescending, anxiety, depression, etc. The system may additionally perform emotional classification by salient feature extraction, or pattern recognition to contextually relevant reference models, patterns, or templates.

In the training and pattern recognition approach to the system emotional labeling, feature extraction and classification, the system preferably applies MFCC extraction on the sample by feature splicing the signal. Thereafter LDA+MLLT transformation are preformed, i.e., linear discriminant analysis and maximum likelihood linear transform. Hidden markov model (HMM) training and deep neural network (DNN) training, with additional feature splicing, and forced alignment, are performed on the sample for machine learning and pattern recognition techniques. In the testing approach, the system inputs speech data and performs MFCC extraction, feature splicing, and LDA+MLLT transformation. Thereafter the sample undergoes additional feature splicing and decoding, with system generated models, and ultimately produces an output label for sample classification. The process may preferably expand the feature set to hundreds of labels per sample. The features are used by the machine learning (ML) classifier Support Vector Machine (SVM) algorithm. The parameters of the SVM model are adjusted by classifying a set of training audio, speaker, and voice samples using a labeled known data set, reference model, or template pattern.

The system preferably samples the agent/customer call and associated audio signal data from a VoIP telephone system network, a recorded audio file, electronically stored data, microphone or sensor. As the audio signal data will have statistical properties which vary over time, or time-varying characteristics, the system will pre-process and divide the signal into frames for a given sampling period, or sampling rate. Dividing the time signal into a series of frames allows analysis with tools that were developed for stationary signals. Preferably, the agent/customer call is sampled at eight to ten kilohertz (8-10 Khz), with a frame size range of one-hundred (100) samples, and ten millisecond (10 ms) time duration. Each frame may preferably consist of a finite number of samples. Individual frames sampled from the speech signal data may be summarized by a set of features, salient emotional features, emotional classification labels, sentiment characteristics, or other application specific organizational schema. The system preferably perceives speech emotion recognition through frequency information, waveform shape, waveform pattern recognition, or waveform amplitude over time varying signal characteristics. The sampled frames may be grouped or clustered according to feature characteristics and the grouping distribution will yield speech emotion recognition patterns. The mel scale may be used by the system for mapping the agent or customer's speech non-linear signal to a linear frequency scale.

The system preferably uses conventional features such as Mel Frequency Cepstral Coefficients (MFCCs), linear prediction cepstral coefficients (LPCCs), filter bank energies, Log Frequency Power Coefficients (LFPC), and frame by frame processing with a twenty millisecond (20 ms) size with ten millisecond (10 ms) shift. Cepstral coefficients are advantageous for information packing properties and thus are ideal for the task of speech recognition and classification. The mel scale allows mapping the speech and voice signals to a linear scale, as frequency content of audio tones is non-linear. Alternatively, other features and frame processing rates, sampling rates and time shifts may be utilized. In addition, the system may preferably use additional global features such as prosodic features, with F-zero (FO) and Energy levels, and applied probabilistic and statistical modeling formula such as computing the average, mean, standard deviation, etc. Speaker rate duration of voiced and unvoiced frames are additionally measured and modeled by the system. The formants F1, F2 and their bandwidths are furthermore sampled, received and modeled by the system. Voice quality features are considered by the system by interpreting signal amplitude, energy, and duration of voiced speech. Additional feature sets may preferably include the Teager Energy Operator (TEO) based features as well as signal modulation features. Fundamental frequencies may be used by the system for recognition of harmonic characteristics and patterns in the system captured voiced speech audio signals.

### Use of Automatic Speech Recognition (Asr) System

In a preferred embodiment of ASR speech to text translation, the system converts spoken words to text by the recognition of words uttered by the speaker in the sampled audio data. The system may preferably utilize Hidden Markov Models (HMMs) in this application. HMM as a statistical model and applied to the presently described speech recognition application would assume the agent or customer's speech is a Markov process with unobserved states. Alternatively, agent or the customer's speech may be represented as a dynamic Bayesian network. Preferably with the MINI approach in the presently described system, the automated process utilizes a statistical model that outputs a sequence of symbols or quantities. The system may use a language model that uses the Markov assumption for a given word state which depends on a fixed number of previous states. The system may preferably use speech recognition as a problem of most likely sequence of state variables or words, as sampled by sound. Additionally, the phrase structure of the agent or customer's speech is interpreted by the system for lowering the error rate of emotional recognition, speech to text translation, and other unique salient feature extraction.

### Acoustic Model to Improve Ser and Asr

The system may furthermore improve accuracy by training a model for the specific call handling system since the voice characteristics are heavily influenced by the technology used. Training the system to adapt to the baseline would enhance the accuracy of the SER as well as the ASR subsystems. Developing an acoustic model consists of adjusting the parameters of the digital signal processing applied at the start to match the frequency response characteristics of the call handling/telephone system used by the call center. These representations are embedded directly into the parameters of the DSP modules. The system also stores these DSP modules in a database to facilitate its rollout in a new call center where similar phone systems are used.

### The System Artificial Intelligence and Machine Learning Features

The presently described system preferably uses an artificial intelligence and machine learning agent for inputting SLA compliance metrics or an SLA compliance referential model for achieving the goal of accurately reporting agent performance and customer satisfaction levels. At a fundamental level, the system may be described as an intelligent agent which has an internal state of providing or predicting SLA metrics, the system acts to provide an output of the application specific SLA metrics in a reporting cycle, whether that is real-time live data, or daily, weekly, or monthly reporting. The system receives input from the environment, i.e., phone call audio sample data, quality assurance data sets, or administrator programmed agent/customer interaction referential models, and updates the internal state, or reporting metrics. The environment is probabilistic and statistically determined by the agent's or customer's input audio samples. In an adaptive reinforcement loop, the system provides the agent's with current SLA performance metrics and therefore modifies the agent's behavior, i.e., in order to achieve higher customer satisfaction, and therefore positively alters the system environment and leads to new input, through agent/customer interaction data.

In a preferred embodiment, the system may determine and predict SLA reporting metrics by applying feature selection and a classification system to a large sampled data set of contextually relevant and call center application specific agent/customer interactions. The system will discover and extract a large number of salient features from the customer call database of recorded interactions and translate this into a large number of classifier parameters that are relevant to predicting SLA metrics. The system will be provided with a training pattern set of agent/customer interactions and limit the feature set in order to design classifiers with proper generalization capabilities and low error rate. The system will preferably select a feature set which provides high discrimination between the agent/customer interactions for improving the accuracy of SLA metric predicting ability. Preferably the system will optimize SLA metric prediction by feature extraction from the agent/customer interaction database, with parallel analysis of a pattern template reference model, for feature selection with maximized efficiency for characterizing for the agent/customer data set.

With the previously described training and testing models, the system is able to process and extract and generate hundreds (100's), or more, of unique features from the speech data in phone calls with MFCC extraction, feature splicing, LDA+MLLT transformation, HMM training, and DNN training, and context specific salient feature ASR/SER data patterns, etc. The data set of agent/customer interactions must be large enough with respect to the number of features in order for the system to have an SLA predicting classifier with sufficiently accurate performance. Additionally, the system will optimize the number of features, given the data set, in order to improve SLA metric predicting performance, but will limit the number of features at the limit where further increases in the number of features results in increase in predicting error. The selection of individual features by the system will furthermore be optimized by the correlation that exists between various features, which influences the classification functionality of the system, and the effectiveness of feature vectors. The system may additionally utilize Bayesian feature selection in order to reduce the number of features, strain on processing resources, lower the error rate, and optimize SLA metric prediction. The system may also use neural networks for feature generation and selection.

In a preferred embodiment of the system, the caller's emotional compatibility is matched with and routed to a call center agent of similar emotional sensibilities. Preferably, the system performs voice audio signal feature extraction and classification on the call center agents and develops a spectrum to organize the agents based on personality types. For example, the call center team may be organized based on agents that fit the different profiles of speech, such as accent, dialect, wordiness, brevity, words per minute, speaking pace, words per minute, soft talkers, loud volume, etc. Alternatively the system may match agents and customers based on personality factors such as openness to experience, conscientiousness, extraversion, introversion, agreeableness, compassion, neuroticism, or emotional stability, etc. The system may match agents and customers based on a variety of personality traits or factors and assign different weights to a composition of numerous factors. The system will perform an initial intake analysis on the customer before matching and routing with a compatible agent. During the intake process an agent or the system automated prompt may ask the customer a series of questions in order to receive spoken voice responses and develop a customer profile. The customer voice sample will preferably be sampled by the system and statistically analyzed for feature extraction, emotional classification and pattern recognition, MFCC extraction, feature splicing, LDA+MLLT transformation, HMM training, DNN training, and context specific salient feature ASR/SER data patterns, etc. Thereafter, the customer will be intelligently routed to an appropriate and available agent with compatibility and sufficient match with the customer's spoken voice feature characteristics.

### Agent Stress Detection System

In another embodiment of the system, the call center agents are monitored for detectable stress levels, indications of excessive workload, and burnout prediction. In this use-case, the system samples the call center agent's voice and performs feature extraction for a set of factors indicative of tiredness, stress, or impeded performance, etc. The system will be provided with a reference model, or template pattern of stress/burnout features for comparison. During job performance duties, taking customer calls, and responding to the customer queue, call center agent's spoken voice audio samples will be scored and analyzed for levels of stress or burnout by comparison and pattern matching with the system reference template. Appropriate notifications may be generated by the system to supervisors and agents indicating that a rest or break period is needed.

### Intelligent Call Search

In a preferred embodiment the system will support an intelligent search feature based on emotional interaction between the call center agents and the caller. This searching functionality will allow call center supervisors to determine how individual agents have handled difficult calls. For example, the supervisor may search an agent's database of agent/customer calls based on predicted SLA metrics. The supervisor may perform a system database query on a given agent, for all calls for customers with salient feature classification of: difficult, angry, upset, demanding, etc., and determine the agent's average resolution or customer satisfaction score for those calls. The supervisor will preferably be able to query the system database for the amount of agent/customer interactions, or cases, in which an agent was able to calm the initially difficult customer, achieve positive trending customer satisfaction, and score over a certain resolution threshold. With this approach, the system will be able to provide useful metric and scoring data for determining individual agent performance, as well as overall call center performance, and thus added value to the contracting business entity end-customer.

1. A method for automatically monitoring service level agreement (SLA) compliance in call centers, comprising:
developing an acoustic model;
adjusting the parameters of the digital signal processing applied at the start of the call to match the frequency response characteristics of the call center telephone system;
directly embedding the frequency response characteristics into the parameters of the digital signal processing modules;
storing the digital signal processing modules in a database to facilitate rollout in new call center applications; and
generating a live stream of agent/customer interaction SLA metrics;
wherein, the method furthermore improves accuracy by training a model for the specific call handling system; and wherein training the system to adapt to the baseline would enhance the accuracy of the speech emotion recognition (SER) and automatic speech recognition (ASR) subsystems.

2. The method for automatically monitoring service level agreement (SLA) compliance in call centers of claim 1, wherein the SLA metrics indicate live customer satisfaction trending direction, upwards, downwards, or evenly, over the course of the agent/customer interaction.

3. The method for automatically monitoring service level agreement (SLA) compliance in call centers of claim 1, wherein the system is trained with reference models and pattern templates that are programmable depending on the specific call center application and SLA requirements.

4. The method for automatically monitoring service level agreement (SLA) compliance in call centers of claim 1, wherein the system is calibrated and adjusted with a set of human generated quality assessment (QA) metrics.

5. The method for automatically monitoring service level agreement (SLA) compliance in call centers of claim 1, wherein the SLA metrics are provided on a live streaming basis, or are searchable for a given agent, customer, time period, or specific compliance metric data point.

6. The method for automatically monitoring service level agreement (SLA) compliance in call centers of claim 1, wherein the system provides the agent with current SLA metrics and modifies the agent's behavior in an adaptive reinforcement loop for positively altering the system environment and achieving higher customer satisfaction.

7. The method for automatically monitoring service level agreement (SLA) compliance in call centers of claim 1, wherein the system optimizes SLA metric prediction by discovering and extracting a set of salient features from a sampled set of agent/customer interaction data, analyzes a training pattern or reference model, and designs a feature set with high discrimination between agent/customer behaviors.

8. A method for automatically monitoring service level agreement (SLA) compliance in call centers, comprising:
sampling the agent/customer phone call audio signal data;
pre-processing the sample with filtering, noise reduction, diarization, and frame division splicing;
performing frame by frame feature extraction with a set of system optimized pattern recognition and identification parameters;
grouping the sample frames into an SLA metric defined classification scheme;
applying a reference pattern template for programming contextual call center application specific environments;
generating a live stream of agent/customer interaction SLA metrics; and
adaptively reinforcing call center agent behavior through live SLA metric reporting and suggested means for customer satisfaction improvement;
wherein the feature extraction comprises conventional features, global features, voice quality features, other features, and salient contextually relevant features.

9. The method for automatically monitoring service level agreement (SLA) compliance in call centers of claim 8, wherein the conventional features comprise mel frequency cepstral coefficients (MFCCs), linear prediction cepstral coefficients (LPCCs), filter bank energies, log frequency power coefficients (LFPC); wherein the global features comprise prosodic features, FO and Energy, their mean, standard deviation, median, speaking rate, duration of voiced and unvoiced frames, formants F1, F2 and their bandwidths; wherein voice quality features comprise signal amplitude, energy, duration of voiced speech; and wherein other features comprise teager energy operator (TEO) based features, and modulation features.

10. The method for automatically monitoring service level agreement (SLA) compliance in call centers of claim 8, wherein the SLA metrics indicate customer satisfaction trending direction, upwards, downwards, or evenly, over the course of the agent/customer interaction.

11. The method for automatically monitoring service level agreement (SLA) compliance in call centers of claim 8, wherein SLA metric generation, call center agent performance, and customer satisfaction are calibrated and adjusted with a set of human generated quality assessment (QA) metrics.

12. The method for automatically monitoring service level agreement (SLA) compliance in call centers of claim 8, wherein the SLA performance metrics are provided on a live streaming basis, or are searchable for a given agent, customer, time period, or specific compliance metric data point.

13. The method for automatically monitoring service level agreement (SLA) compliance in call centers of claim 8, where the system provides the agent with current SLA performance metrics and modifies the agent's behavior in an adaptive reinforcement loop for positively altering the system environment and achieving higher customer satisfaction.

14. The method for automatically monitoring service level agreement (SLA) compliance in call centers of claim 8, wherein the system optimizes SLA prediction by discovering and extracting a set of salient features from a sampled set of agent/customer interaction data, analyzing a training pattern or reference model, and designing a feature set with high discrimination between agent/customer behaviors.

15. A system for automatically monitoring service level agreement (SLA) compliance in call centers, comprising:
a software application for sampling the agent/customer phone call audio signal data and performing pre-processing, filtering, noise reduction, and speaker diarization;
a feature extraction engine for dividing the audio sample into frames, and extracting a set of features for pattern recognition and classification;
an artificial intelligence agent for grouping each frame according to an SLA metric defined classification scheme;
a user interface application for viewing system generated SLA metrics indicating call center agent performance and customer satisfaction; and
an adaptive machine learning agent for optimizing call center agent behavior through live SLA metric reporting and suggested means for customer satisfaction improvement;
wherein the feature extraction comprises conventional features, global features, voice quality features, other features, and salient contextually relevant features.

16. The system for automatically monitoring service level agreement (SLA) compliance in call centers of claim 15, wherein the conventional features comprise mel frequency cepstral coefficients (MFCCs), linear prediction cepstral coefficients (LPCCs), filter bank energies, log frequency power coefficients (LFPC); wherein the global features comprise prosodic features, FO and Energy, their mean, standard deviation, median, speaking rate, duration of voiced and unvoiced frames, formants F1, F2 and their bandwidths; wherein voice quality features comprise signal amplitude, energy, duration of voiced speech; and wherein other features comprise teager energy operator (TEO) based features, and modulation features.

17. The system for automatically monitoring service level agreement (SLA) compliance in call centers of claim 15, wherein the SLA metrics indicate customer satisfaction trending direction, upwards, downwards, or evenly, over the course of the agent/customer interaction.

18. The system for automatically monitoring service level agreement (SLA) compliance in call centers of claim 15, wherein the SLA metric generation, call center agent performance, and customer satisfaction are calibrated and adjusted with a set of human generated quality assessment (QA) metrics.

19. The system for automatically monitoring service level agreement (SLA) compliance in call centers of claim 15, wherein the SLA performance metrics are provided on a live streaming basis, or are searchable for a given agent, customer, time period, or specific compliance metric data point.

20. The system for automatically monitoring service level agreement (SLA) compliance in call centers of claim 15, wherein the system optimizes SLA prediction by discovering and extracting a set of salient features from a sampled set of agent/customer interaction data, analyzing a training pattern or reference model, and designing a feature set with high discrimination between agent/customer behaviors.
